(19) United States
(12) Patent Application Publication
(10) Pub. No.: US 2017/0080620 A1
(43) Pub. Date: Mar. 23, 2017

(54) METHOD FOR PRODUCING A RECEPTACLE, RECEPTACLE OBTAINED ACCORDING TO SAID METHOD AND DEVICE FOR PRODUCING THE RECEPTACLE

(71) Applicant: ALBEA SERVICES, Gennevilliers (FR)

(72) Inventor: Victor Ramos, Rambouillet (FR)

(21) Appl. No.: 15/311,978

(22) PCT Filed: May 22, 2015
(86) PCT No.: PCT/EP2015/061357

§ 371 Date: Nov. 17, 2016

(30) Foreign Application Priority Data
May 28, 2014 (FR) 1454820

(51) Int. Cl. B29C 45/56; B29C 45/20; B29C 45/00

(52) U.S. Cl. CPC B29C 45/56; B29C 45/0001; B29C 45/20; B29K 2067/00

(57) ABSTRACT

A method for producing a receptacle, in particular a receptacle for a cosmetic product, includes injecting a material into a moulding cavity in an injection step. The moulding cavity is expanded during the injection step in such a way as to increase the thickness of a wall of the receptacle in a separation step. A receptacle is obtained using such a method and a device is used for implementing said method.

The invention relates to a method for manufacturing a container, in particular a pot, more particularly a pot for a cosmetic product, to a container obtained in accordance with said method and to a device for manufacturing the container.

Pots for cosmetic products that are made of plastics material are known. These pots comprise a circular lateral wall and a base. The bases may be very thick, for example approximately 10 mm, in particular compared with the lateral wall. However, the thickness that an injection nozzle is capable of producing while minimising the effect of furrows around the point of injection is directly linked to the diameter of the opening in the nozzle through which the material enters the mould. Therefore, for high wall thicknesses, a standard injection nozzle of which the opening diameter is low, in particular to minimise the appearance of the point of injection on the pot, only makes it possible to obtain a pot having significant filling furrows around the point of injection. Such furrows would be deemed unsightly by professionals in the field.

One known solution for avoiding this drawback is to multiply the number of nozzles used to produce the pot while carrying out successive injection operations. A solution of this type indeed makes it possible to reduce the volume to be filled with material by an injection nozzle. Another known solution involves carrying out the injection in two steps, i.e. by carrying out a first injection in order to produce a first shape of the container, and then a second injection, overmoulded around the first injection. However, these two solutions require the use of an expensive device that has a plurality of nozzles or is configured to carry out overmoulding. Furthermore, these solutions leave visible marks on the pot at the point where the material coming from different nozzles meets or at the point where the material is overmoulded around the first shape that is produced.

The invention aims to improve the situation. For this purpose, said invention relates to a method for manufacturing a container, in particular a container for a cosmetic product, in which material is injected into a mould cavity in a step referred to as the injection step, characterised in that the mould cavity is enlarged during the injection so as to increase the thickness of a wall of the container in a step referred to as the moving-away step.

Adjusting the size of the mould cavity makes it possible to reduce the initial volume that the nozzle has to fill, and then to increase said volume gradually, following the pace of filling, in order to obtain the desired thickness. In this way, the invention proposes allowing a single injection nozzle to be used, which has an injection opening of which the diameter is less than the thickness of said wall, without obtaining ripple effects or the marks encountered in the solutions from the prior art.

According to various embodiments of the invention, which can be taken together or separately:
said container is injection-moulded in a single injection operation, in a single layer of material,
said material is injected opposite a core by means of an injection station and the core is moved away from the injection station during said moving-away step in order to increase the thickness of the wall of the container between the core and the injection station;
said material is injected by said injection station by means of a single injection nozzle;
the injection step begins before the moving-away step;
the moving-away step includes a step of moving the core between a first position that defines a first material thickness of the wall of the container and a second position of the core, the moving-away step beginning at the point at which the injection step has formed said first material thickness;
the first position of the core defines a thickness of the wall of between 2 and 5 mm and the second position of the core defines a thickness of the wall of between 9 and 12 mm;
the injection material is part of the family of copolyesters.

Advantageously, the invention also relates to a container obtained in accordance with the method as described above. The container is in particular rigid.

Advantageously, the invention also relates to a device for manufacturing a container, in particular a container for a cosmetic product, which device comprises a mould cavity and means for injecting a material into said mould cavity, said device being designed to enlarge the mould cavity during the injection so as to increase the thickness of a wall of the container.

According to various embodiments of the invention, which may be taken together or separately:
said injecting means comprise an injection station;
said mould cavity comprises a core arranged to move relative to said injection station;
said device comprises a mechanism for driving said core, designed to move said core relative to said injection station;
said mechanism for driving said core is a gear assembly;
the gear assembly comprises a planet gear, and a toothed wheel arranged so that the planet gear rotates the toothed wheel;
the toothed wheel is in a helical connection with said core;
the toothed wheel is in a helical connection with said core by means of an intermediate part;
the intermediate part is detachably mounted on said core;
the injection station comprises an injection nozzle comprising an injection opening having a diameter of between 2 and 5 mm.

The invention will be better understood, and its other aims, details, features and advantages will become clearer in the following detailed explanatory description of at least one embodiment of the invention given as a purely illustrative and non-limiting example, with reference to the accompanying schematic drawings, in which:

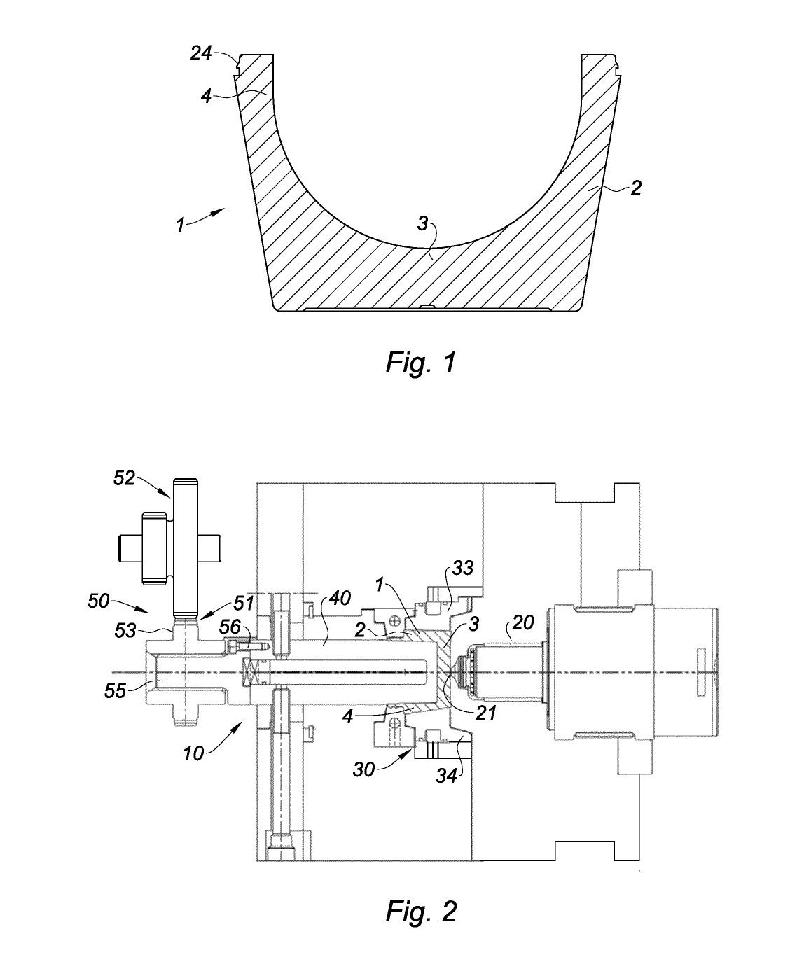

FIG. 1 is a schematic axial section through an embodiment of a container according to the invention;

FIG. 2 is an axial section through an injection device according to the invention;

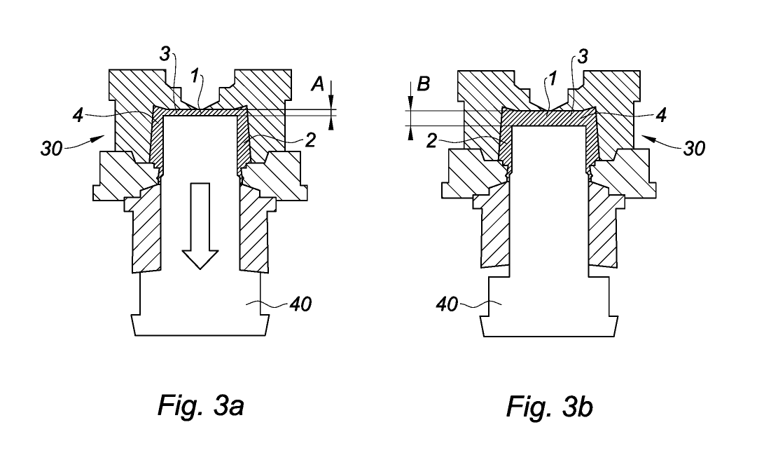

FIG. 3a is a schematic axial section through a part of the injection device according to the invention shown in a first step of the injection;

FIG. 3b is a view similar to FIG. 1a, showing the injection device according to the invention in a second step of the injection.

As shown in FIG. 1, the invention relates to a container 1, in particular a pot for a cosmetic product such as cream. The container 1 of the invention is in particular rigid. “Rigid” is intended to mean a container that cannot be deformed, at least without breaking, as opposed to a relatively flexible container, such as the tubes used in the field of cosmetics.

Here, the container 1 comprises a lateral wall 2 and a bottom wall, referred to as the base 3. The lateral wall 2 and the base 3 form a body 4 formed by a single layer of material, in particular from the family of copolyesters. Here, the lateral wall 2 comprises a neck 24 having technical shaped portions that allow it to engage with a cover (not shown), for example.

The container 1 is shown in FIG. 2 during production in an injection device 10 according to the invention.

The injection device 10 comprises a mould 30 equipped with an injection station 20 and a core 40. The mould 30 defines a mould cavity of the container 1, in particular located between the core 40 and said injection station 20. In this case, material is injected into the inside of the mould in order to manufacture the container 1 via an injection nozzle 21 of the injection station 20. The material is, for example, injected around the core 40. The injection takes place between at least two shells 33, 34 of the mould 30, which is of course closed during the injection. The container 1 is injection-moulded in a single injection operation and therefore in a single layer of material.

This being so, according to the invention, the mould cavity is enlarged during the injection so as to increase the thickness of at least one of the walls 3 of the container 1, in this case the base 3, in a step referred to as the moving-away step. The container of the invention is therefore not manufactured by overmoulding. This results in there not being a visible trace of mixing of the material since there is no overlap region of the overmoulding.

The injection station 20 advantageously comprises a single injection nozzle 21. Therefore, the material is injected by the injection station 20 by means of a single injection opening. In other words, the container of the invention is not manufactured by bi-injection moulding. This results in there not being a visible trace of mixing of the material since there is no region in which the materials, which would come from a plurality of nozzles, meet.

The injection device 10 may comprise a mechanism 50 for driving the core 40 which is designed to move the core 40 relative to the injection station 20. The core 40 can therefore be moved during the injection of material.

The method for manufacturing the container 1 according to the invention in fact advantageously provides an injection step during which the material is injected around the core 40 by means of the injection station 20, the moving-away step thus serving to move the core 40 away from the injection station 10 by means of the drive mechanism 50 so as to increase the thickness of the base 3. Part of the injection step and the movement of the core 40 take place simultaneously, for example.

Following the moving-away step and a possible cooling step, the mould is opened and the container 1 is retrieved.

The injection device 10 makes it possible to implement the method for manufacturing the container 1 of the invention.

Therefore, owing to the invention, the core 40 can move during the injection of material into the mould so as to increase, in particular in a regular manner, the thickness of the base 3 of the container 1, in order to prevent the problems caused by injection into a volume that is too large in relation to the diameter of the opening in the injection nozzle 21, as explained above.

Here, the drive mechanism 50 comprises a gear assembly 51. The gear assembly 51 is particularly advantageous since it makes it possible to precisely control the position of the core 40 relative to the injection station 20 while effectively resisting the pressure exerted on the core 40 by the injection of the material into the mould. The gear assembly 51 also makes it possible to obtain a regular movement of the core 40, i.e. a constant and/or smooth movement. The gear assembly 51 also has the advantage of being cost-effective. This mechanism may of course also be a different drive mechanism, such as a cam mechanism.

The gear assembly 51 for example comprises a planet gear 52 that in particular makes it possible to reduce the torque from a motor (not shown) for driving the gear assembly. Here, the gear assembly 51 comprises a toothed wheel 53 that meshes with the planet gear 52. The rotation of the planet gear 52 thus allows the toothed wheel 53 to be rotated.

With the aim of moving the core 40 relative to the injection station 20, the toothed wheel 53 is in a helical connection with the core 40 in this case. Therefore, following the rotation of the planet gear 52 and then of the toothed wheel 53, the core 40 would move in translation relative to the injection station 20. The core 40 thus moves away from the injection station 20 during the injection of the material into the mould or moves closer to the injection station 20 in order to prepare the injection device 10 for a new injection. The core 40 would in particular move between a first position shown in FIG. 3a and a second position shown in FIG. 3b.

Here, the toothed wheel 53 is in a helical connection with the core 40 by means of an intermediate part 55. This intermediate part 55 is in particular inserted into the toothed wheel 53. It comprises, for example, an external thread connected to an internal thread of the toothed wheel 53, or vice versa. The intermediate part 55 is advantageously detachably mounted on the core 40. In this case, it is detachably mounted relative to the core by means of a screw 56. Therefore, it is possible to produce different containers 1 solely by changing the core 40 of the injection device 10 and by positioning the new core on the intermediate part 55.

The moving-away step moves the core 40 between a first position that is shown in FIG. 3a and defines a first material thickness of the wall of the container, and a second position of the core 40 shown in FIG. 3b. According to the invention, the moving-away step begins after the start of the injection step. This means that the moving-away step does not begin as long as the injection step has not begun. Advantageously, the moving-away step begins at the point when the injection step has formed the first material thickness of the base.

In other words, the injection step begins when the core 40 is in its first position. The core 40 remains in its first position when the first thickness has not been filled with material, i.e. until the point shown in FIG. 3a. At this point, i.e. when the mould is filled with material, the moving-away step begins, i.e. the drive mechanism begins to drive the core 40 from its first position into its second position shown in FIG. 3b, i.e. until the desired thickness of the base 3 is obtained.

The first position of the core 40 for example defines a thickness A of the base of between 2 and 5 mm and the second position of the core defines a thickness B of the base of between 9 and 12 mm.

Owing to the invention, the nozzle 21 of the injection station 20 may comprise an injection opening of which the diameter is standard, in particular between 2 and 5 mm, without causing the phenomena of furrows around the point of injection.

The invention also makes it possible to use materials, in particular from the family of copolyesters, which can be injected to a thickness equivalent to the opening diameter of the injection nozzle without creating the above-mentioned defects, such as ripples around the point of injection.

Therefore, the injection station 20 would inject material into the mould until a first thickness of the base 3 of the container 1 of approximately 2 to 5 mm is produced, and then the drive mechanism would drive the core 40 until the desired thickness is reached, in particular 9 to 12 mm, without producing ripples around the point of injection.

According to the invention, a plurality of injection devices 10 of the invention can be arranged in series and/or in parallel in order to increase the production frequency. The injection devices 10 would for example be arranged beside one another and/or so as to be symmetrical, for example with the injection stations 20 being located opposite one another and the drive mechanisms 50 being located back to back.

1. Method for manufacturing a container, in particular a container for a cosmetic product, in which a material is injected into a mould cavity in a step referred to as the injection step, wherein the mould cavity is enlarged during the injection so as to increase the thickness of a wall of the container in a step referred to as the moving-away step.

2. Manufacturing method according to claim 1, wherein said container is injection-moulded in a single injection operation, in a single layer of material.

3. Manufacturing method according to claim 1, wherein the injection step begins before the moving-away step.

4. Manufacturing method according to claim 1, wherein said material is injected opposite a core by means of an injection station and the core is moved away from the injection station during the moving-away step in order to increase the thickness of the wall of the container between the core and the injection station.

5. Manufacturing method according to claim 4, wherein said material is injected by said injection station by means of a single injection nozzle.

6. Manufacturing method according to claim 4, wherein the moving-away step includes a step of moving the core between a first position that defines a first material thickness of the wall of the container and a second position of the core, the moving-away step beginning at the point at which the injection step has formed said first material thickness.

7. Manufacturing method according to claim 6, wherein the first position of the core defines a thickness of the wall of between 2 and 5 mm and the second position of the core defines a thickness of the wall of between 9 and 12 mm.

8. Manufacturing method according to claim 7, wherein the injection material is part of the family of copolyesters.

9. Container obtained using the method according to claim 1.

10. Device for manufacturing a container, in particular a container for a cosmetic product, which device comprises a mould cavity and means for injecting a material into said mould cavity, said device being designed to enlarge the mould cavity during the injection so as to increase the thickness of a wall of the container.

11. Device according to claim 10, wherein
said injecting means comprise an injection station,
said mould cavity comprises a core arranged to move relative to said injection station,
said device further comprises a mechanism for driving said core, designed to move said core relative to said injection station.

12. Device according to claim 11, wherein said mechanism for driving said core is a gear assembly.

13. Device according to claim 12, wherein the gear assembly comprises a planet gear, and a toothed wheel arranged so that the planet gear rotates the toothed wheel.

14. Device according to claim 13, wherein the toothed wheel is in a helical connection with said core by means of an intermediate part that is detachably mounted on said core.

15. Device according to claim 10, wherein the injection station comprises an injection nozzle comprising an injection opening having a diameter of between 2 and 5 mm.
